(19) United States
(12) Patent Application Publication
(10) Pub. No.: US 2026/0364849 A1
(43) Pub. Date: Nov. 19, 2026

(54) CONTROL METHOD FOR WIRE CUTTING MACHINE, CONTROL APPARATUS, AND WIRE CUTTING MACHINE

(71) Applicant: QINGDAO GAOCE TECHNOLOGY CO., LTD., Qingdao (CN)

(72) Inventors: Deyan HU, Qingdao (CN); Xusheng ZHUANG, Qingdao (CN); Fengyan SHANG, Qingdao (CN); Zuoke XU, Qingdao (CN); Xinkai ZHANG, Qingdao (CN); Yi ZHANG, Qingdao (CN); Ruiguang ZHAO, Qingdao (CN); Dang GUO, Qingdao (CN); Yuhui LI, Qingdao (CN); Yunqing GONG, Qingdao (CN); Yu CHEN, Qingdao (CN)

(21) Appl. No.: 19/155,230

(22) PCT Filed: Jan. 31, 2024
(86) PCT No.: PCT/CN2024/074990

§ 371 Date: Aug. 8, 2025

(30) Foreign Application Priority Data
Feb. 9, 2023 (CN) 202310103928.1
Feb. 9, 2023 (CN) 202320198781.4

(51) Int. Cl. B28D 5/00; B28D 5/04

(52) U.S. Cl. CPC B28D 5/0064; B28D 5/045

(57) ABSTRACT

A control method for a wire cutting machine, comprising: judging whether a preset shaft diameter change condition is met; if met, calculating a target rotational speed of a wire roller (41); and causing the current rotational speed of the wire roller (41) to be the target rotational speed, so that the linear speed difference between a linear speed of a cutting wire (3) on the wire roller (41) and a linear speed of a cutting wire (3) on a main roller (1) is within a set difference. By the arrangement, the consistency between said linear speeds can be improved, thereby ensuring that the tension on a cutting wire net is more uniform and a tension swing rod is more stable, so that the probability of wire jumping or wire breakage in the machining process can be reduced to ensure the machining speed and the machining quality. The present invention further relates to a control apparatus and a wire cutting machine.

### CROSS-REFERENCE TO RELATED APPLICATIONS

The present application claims priority from Chinese patent application No. CN202310103928.1 and entitled “CONTROL METHOD FOR WIRE CUTTING MACHINE, MEDIUM, CONTROL APPARATUS, AND WIRE CUTTING MACHINE”, and Chinese patent application No. 202320198781.4 and entitled “WIRE SAW UNIT AND WIRE CUTTING MACHINE”, both of which were filed on Feb. 9, 2023 and the entire disclosures of which are incorporated herein by reference.

### FIELD OF THE INVENTION

The present disclosure relates to the technical field of wire cutting, and specifically to a control method and control device for a wire cutting machine, and a wire cutting machine.

### BACKGROUND OF THE INVENTION

Wire cutting is a cutting and processing method that cuts workpieces-to-be-cut (such as silicon rods, silicon carbide, semiconductors, sapphire, magnetic materials, etc.) through high-speed reciprocating motion of a cutting wire relative to the workpieces-to-be-cut. A wire cutting machine mainly includes a cutting assembly, a feeding assembly, a winding assembly, a liquid circuit assembly, and an electrical control box.

During a cutting process of the wire cutting machine, the cutting wire is released from a wire roller on one side, passes through a routing mechanism on that side, and then is wound around a cutting mechanism to achieve cutting of the workpiece-to-be-cut. The cutting wire coming out of the cutting mechanism is stored on a wire roller on the other side after passing through a routing mechanism on the other side. The wire rollers on both sides take turns winding and unwinding the wire to achieve reciprocating motion of the cutting wire. When the wire roller is unwinding, as the unwinding process progresses, an outer diameter of the wire roller gradually decreases. When the wire roller is winding, as the winding process progresses, the outer diameter of the wire roller gradually increases. The control of each motor is determined by the wire speed and the diameter of rotating shaft. Changes in the diameter of the wire roller during the cutting process can cause the actual wire speed on the surface of the wire roller to be different from the actual wire speed at the main roller. If not controlled, it can lead to wire jumping or wire breakage during the processing, seriously affecting the processing speed and processing quality.

Accordingly, there is a need for a new technical solution in the art to solve the above problems.

### SUMMARY OF THE INVENTION

In order to solve at least one of the above-mentioned problems in the prior art, i.e., to solve the problem of wire jumping or wire breakage caused by changes in the diameter of the wire roller during the processing of existing wire cutting machines, the present application provides a control method for a wire cutting machine; the wire cutting machine includes a cutting assembly and a winding assembly, the cutting assembly includes multiple main rollers, the winding assembly includes a winding/unwinding mechanism that includes a wire roller, and the control method includes: judging whether the wire roller meets a preset shaft diameter change condition; calculating a target rotational speed n2 of the wire roller if the preset shaft diameter change condition is met; and controlling the current rotational speed of the wire roller to be the target rotational speed n2, so that a difference between the wire speed of the cutting wire on the wire roller and the wire speed of the cutting wire on the main roller is within a set difference.

By setting a preset shaft diameter change condition, the target rotational speed of the wire roller is recalculated when the preset shaft diameter change condition is met, and the current rotational speed of the wire roller is controlled to be the target rotational speed, so that a difference between the wire speed of the cutting wire on the wire roller and the wire speed of the cutting wire on the main roller is within a set difference, thereby improving the consistency between the wire speed of the cutting wire on the wire roller and the wire speed of the cutting wire on the main roller. It is ensured that the tension on the cutting wire network is more uniform and the tension swing rod is more stable, thereby reducing the probability of wire jumping or wire breakage during the processing, and ensuring the processing speed and processing quality.

The present application also provides a wire cutting machine, which includes a wire saw unit; the wire saw unit includes a first winding/unwinding assembly and a second winding/unwinding assembly, which are respectively arranged on two opposite sides of a main roller assembly, and the arrangement direction of the first winding/unwinding assembly is opposite to that of the second winding/unwinding assembly.

By arranging the first winding/unwinding assembly and the second winding/unwinding assembly in opposite directions, a routing path of the cutting wire can be extended when the winding/unwinding assembly on one side is in the winding state. In this way, the cutting liquid adhered to the cutting wire is dried during the routing process, effectively reducing the accumulation of powder in the winding chamber and on the winding/unwinding roller, and improving the operational stability of the winding/unwinding roller.

### BRIEF DESCRIPTION OF THE DRAWINGS

The wire cutting machine and its control method, medium, and control device of the present application will be described below with reference to the accompanying drawings. In the drawings:

FIG. 1 is a schematic structural view of a first embodiment of the wire cutting machine of the present application;

FIG. 2 is a schematic structural view of a winding/unwinding mechanism in the first embodiment of the wire cutting machine of the present application;

FIG. 3 is a schematic structural view of a tension mechanism in the first embodiment of the wire cutting machine of the present application;

FIG. 4 is a first schematic view of routing of the cutting wire in the first embodiment of the wire cutting machine of the present application;

FIG. 5 is a second schematic view of routing of the cutting wire in the first embodiment of the wire cutting machine of the present application;

FIG. 6 is a flowchart of the control method for the first embodiment of the wire cutting machine of the present application;

FIG. 7 is a flowchart of a first embodiment of the control method for the first embodiment of the wire cutting machine of the present application;

FIG. 8 is a flowchart of a second embodiment of the control method for the first embodiment of the wire cutting machine of the present application;

FIG. 9 is a schematic view of the layout of a wire saw unit in the prior art;

FIG. 10 is an assembly view of a wire saw unit in a second embodiment of the wire cutting machine of the present application;

FIG. 11 is an assembly view of the wire saw unit in the second embodiment of the wire cutting machine of the present application from another perspective;

FIG. 12 is a schematic view of the layout of the wire saw unit in the second embodiment of the wire cutting machine of the present application; and

FIG. 13 is a cross-sectional view of the second embodiment of the wire cutting machine of the present application.

### LIST OF REFERENCE SIGNS

### First Embodiment

1: main roller; 2: cutting chamber; 3: cutting wire; 4: winding/unwinding mechanism; 41: wire roller; 42: first motor; 5: tension mechanism; 51: tension swing rod; 52: tension guide wheel; 53: second motor; 6: wiring mechanism; 7: steering wheel mechanism.

### Second Embodiment

11: first winding/unwinding assembly; 111: first driving mechanism; 112: first winding/unwinding roller; 12: second winding/unwinding assembly; 121: second driving mechanism; 122: second winding/unwinding roller; 21: first wiring wheel assembly; 22: second wiring wheel assembly; 31: first tension wheel assembly; 32: second tension wheel assembly; 41: first steering wheel assembly; 42: second steering wheel assembly; 50: cutting frame; 51: first winding chamber; 52: second winding chamber; 53: cutting chamber; 60: cutting wire; 70: main roller assembly; 81: third winding/unwinding assembly; 82: fourth winding/unwinding assembly.

### DETAILED DESCRIPTION OF THE EMBODIMENT(S) OF THE INVENTION

Preferred embodiments of the present application will be described below with reference to the accompanying drawings. It should be understood by those skilled in the art that these embodiments are only used to explain the technical principles of the present application, and are not intended to limit the scope of protection of the present application.

It should be noted that in the description of the present application, directional or positional relationships indicated by terms such as “top”, “bottom”, “left”, “right”, “vertical” and “horizontal” are based on the directional or positional relationships shown in the drawings. They are merely used for the convenience of description, and do not indicate or imply that the device or element involved must have a specific orientation, or be configured or operated in a specific orientation, and therefore they should not be construed as limiting the present application. In addition, terms “first” and “second” are used for descriptive purpose only, and should not be construed as indicating or implying relative importance.

In addition, it should also be noted that in the description of the present application, unless otherwise clearly specified and defined, terms “install”, “connect” and “connection” should be understood in a broad sense; for example, the connection may be a fixed connection, or a detachable connection, or an integral connection; it may be a mechanical connection, or an electrical connection; it may be a direct connection, or an indirect connection implemented through an intermediate medium, or it may be an internal communication between two elements. For those skilled in the art, the specific meaning of the above terms in the present application can be understood according to specific situations.

### First Embodiment

The technical solution of a first preferred embodiment of the present application will be described below in detail with reference to FIGS. 1 to 8.

Firstly, referring to FIGS. 1 to 3, the wire cutting machine of the present application will be described.

As shown in FIG. 1, the wire cutting machine of the present application includes a cutting assembly and a winding assembly.

The cutting assembly includes multiple main rollers 1 and driving devices for driving the main rollers 1 to rotate. The multiple main rollers 1 are generally arranged in parallel and located in a cutting chamber 2 of the wire cutting machine. The driving devices include multiple motors (not shown in the figure), which are drivingly connected to the corresponding main rollers 1 respectively, and can drive their respective main rollers 1 to rotate. A cutting wire 3 is arranged on the main rollers 1, and it is spirally arranged on the multiple main rollers 1 at a certain distance to form a cutting wire network. Multi-wire cutting work is achieved through grinding between the cutting wire network and workpieces-to-be-cut.

It should be noted that the number of main rollers 1 can be two, three, or four, etc. Correspondingly, the number of motors used to drive the main rollers 1 to rotate can also be two, three, or four, etc. Such adjustments and changes to the specific number of main rollers 1 do not deviate from the principles and scope of the present disclosure, and should all be defined within the scope of protection of the present disclosure.

As shown in FIG. 1, the winding assembly includes winding/unwinding mechanisms 4 and tension mechanisms 5. The winding/unwinding mechanism 4 is used for unwinding and winding the cutting wire 3, and there are two winding/unwinding mechanisms 4 located on both sides of the cutting assembly respectively. During operation, one of the winding/unwinding mechanisms 4 is used for unwinding the cutting wire 3, and the other one of the winding/unwinding mechanisms 4 is used for winding the cutting wire 3. The tension mechanism 5 is used for tension control of the cutting wire 3, ensuring that the entire cutting wire 3 is stretched and tensioned during operation.

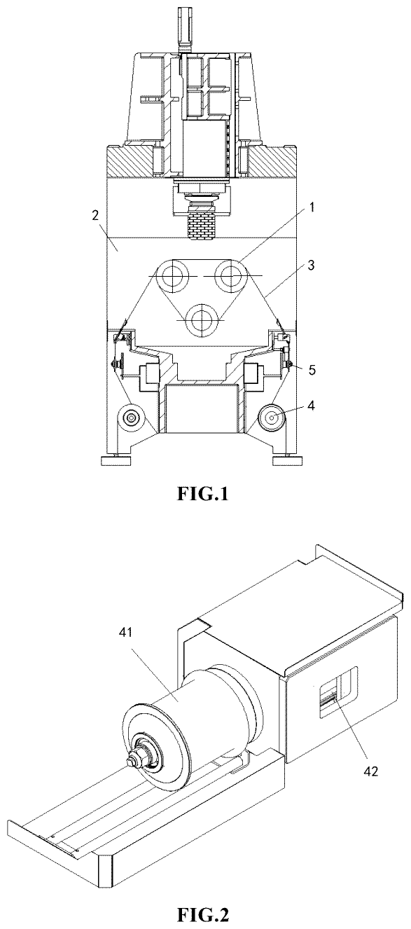

As shown in FIG. 2, the winding/unwinding mechanism 4 includes a wire roller 41 and a motor (referred to as a first motor 42) for driving the wire roller 41 to rotate. The cutting wire 3 is wound around the wire roller 41. When the first motor 42 drives the wire roller 41 to rotate in the forward direction, the wire roller 41 is in an unwinding state. When the first motor 42 drives the wire roller 41 to rotate in the reverse direction, the wire roller 41 is in a winding state.

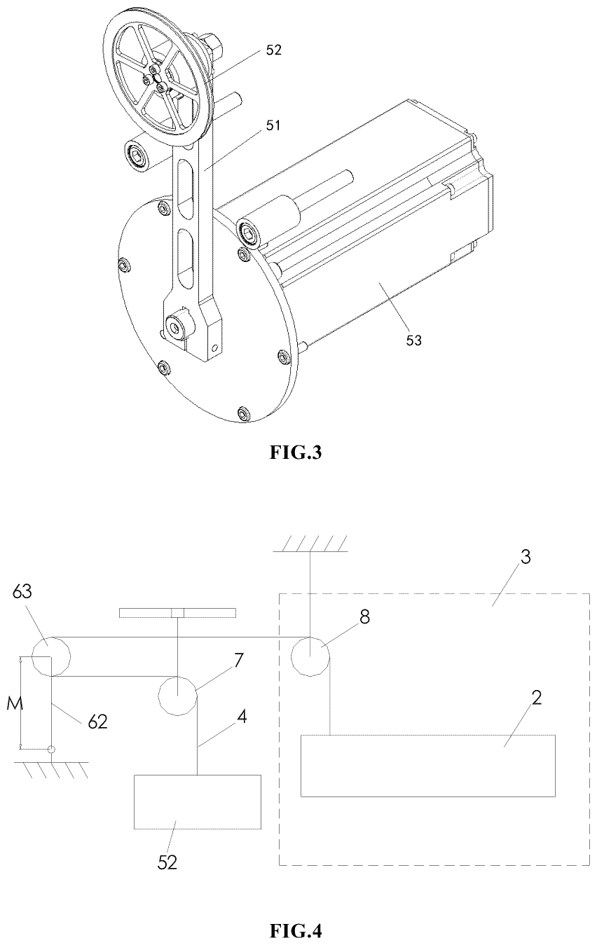

As shown in FIG. 3, the tension mechanism 5 includes a tension swing rod 51, a tension guide wheel 52, and a motor (referred to as a second motor 53) for driving the tension swing rod 51 to swing. A bottom end of the tension swing rod 51 is fixedly connected to an output shaft of the second motor 53, and the tension guide wheel 52 is rotatably installed at a top end of the tension swing rod 51.

It should be noted that as shown in FIGS. 4 and 5, in addition to the winding/unwinding mechanisms 4 and the tension mechanisms 5 introduced above, the winding assembly further includes wiring mechanisms 6 and steering wheel mechanisms 7. The wiring mechanism 6 is installed between the wire roller 41 and the tension mechanism 5 to arrange the cutting wire 3 on the wire roller 41 at a certain pitch. The steering wheel mechanism 7 is installed between the tension mechanism 5 and the main roller 1 to change the direction of the cutting wire 3, so that the cutting wire 3 can be smoothly wound around the main roller 1. The wire cutting machine of the present application can adopt any structural form of wiring mechanism 6 and steering wheel mechanism 7 in the prior art.

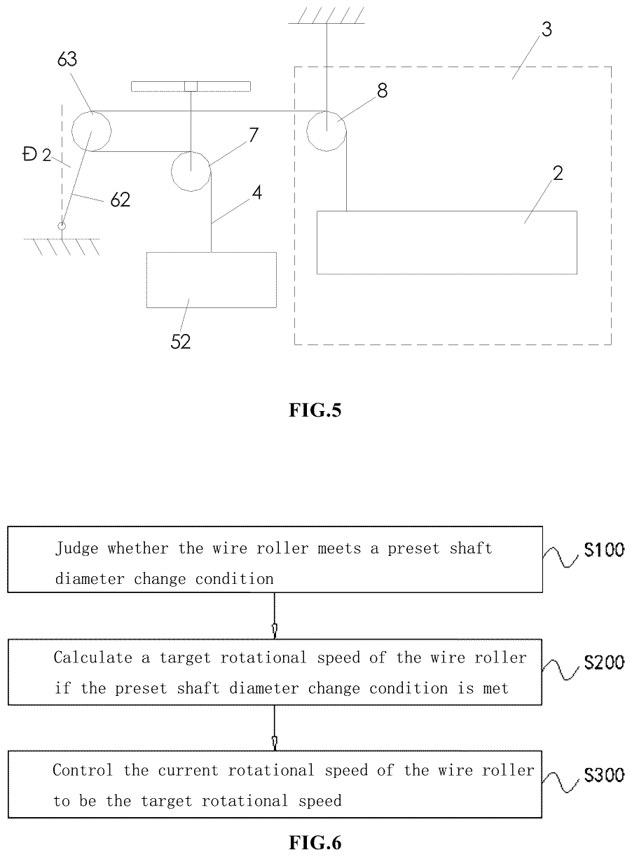

Next, with reference to FIGS. 6 to 8, the control method for a wire cutting machine of the present application will be described.

As shown in FIG. 6, the control method for a wire cutting machine of the present application includes steps S100 to S300.

S100: judging whether the wire roller 41 meets a preset shaft diameter change condition;

S200: calculating a target rotational speed n2 of the wire roller 41 if the preset shaft diameter change condition is met; and

S300: controlling the current rotational speed of the wire roller 41 to be the target rotational speed n2, so that a difference between the wire speed of the cutting wire 3 on the wire roller 41 and the wire speed of the cutting wire 3 on the main roller 1 is within a set difference.

By setting a preset shaft diameter change condition, the target rotational speed of the wire roller 41 is calculated when the wire roller 41 meets the preset shaft diameter change condition, and the wire roller 41 is controlled to rotate at the new target rotational speed, so that a difference between the wire speed of the cutting wire 3 on the wire roller 41 and the wire speed of the cutting wire 3 on the main roller 1 is within a set difference, thereby improving the consistency between the wire speed of the cutting wire on the wire roller and the wire speed of the cutting wire on the main roller. The two wire speeds are basically the same, so that the consistency between the wire speed of the cutting wire on the wire roller and the wire speed of the cutting wire on the main roller can be improved. It is ensured that the tension on the cutting wire network is more uniform and the tension swing rod is more stable, thereby reducing the probability of wire jumping or wire breakage during the processing, and ensuring the processing speed and processing quality.

Specifically, when calculating the target rotational speed of the wire roller 41, the target rotational speed of the wire roller 41 can be calculated based on the recorded main roller parameters, swing rod parameters, and wire roller parameters. The main roller parameters include the wire speed of the cutting wire 3 on the main roller 1 and position data of the main roller 1, etc.; the swing rod parameters include position data and swing rod length of the tension swing rod 51, etc.; and the wire roller parameters include the wire speed of the cutting wire 3 on the wire roller 41 and position data of the wire roller 41, etc.

It should be noted that in practical applications, those skilled in the art can flexibly set the specific value of the set difference based on experiments or experience. The value range of the set difference can be any value from 0.1 m/min to 0.8 m/min, such as 0.1 m/min, 0.3 m/min, 0.5 m/min, 0.6 m/min, and 0.8 m/min. In the following example, the set difference is specifically set to 0.3 m/min.

For example, the set difference can be set to 0.3 m/min, which means that by controlling the current rotational speed of the wire roller 41 to be the new target rotational speed n2, the wire speed difference between the cutting wire 3 on the wire roller 41 and the cutting wire 3 on the main roller 1 can be kept within 0.3 m/min.

In addition, it should also be noted that in practical applications, those skilled in the art can set a reference routing amount for the routing amount of the main roller 1, and the preset shaft diameter change condition can be set as the routing amount of the main roller 1 being larger than the reference routing amount. Alternatively, they can set a preset interval for the change angle of the tension swing rod 51, and the preset shaft diameter change condition can be set as the change angle of the tension swing rod 51 exceeding the preset interval. Alternatively, they can set the preset shaft diameter change condition as the working duration or workload of the wire roller 41 reaching a set value, etc. Such adjustments and changes to the specific content of the preset shaft diameter change condition do not deviate from the principles and scope of the present disclosure, and should all be defined within the scope of protection of the present disclosure.

The control method of the present application will be described below in detail in connection with two preferred examples.

### First Preferred Example

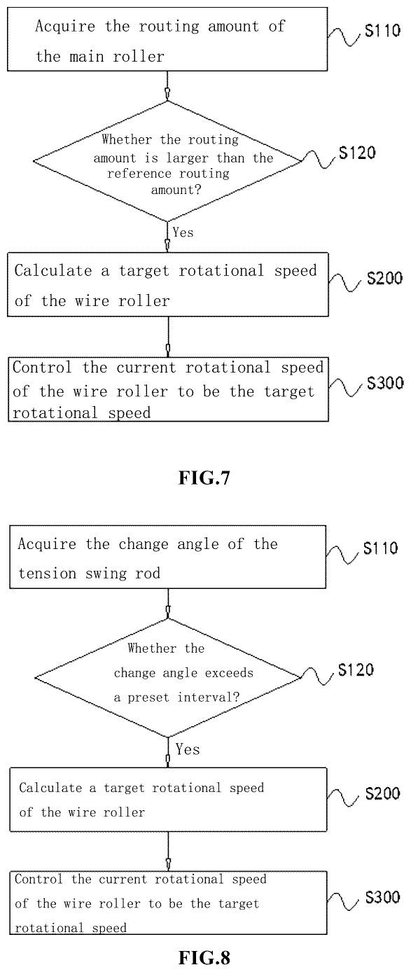

As shown in FIG. 7, the control method of this embodiment includes the following steps S110, S120, S200 and S300.

S110: acquiring the routing amount S1 of the main roller 1.

For example, the routing amount S1 of the main roller 1 is π×d1×N1, where d1 is the diameter of the main roller 1, and N1 is the number of turns of rotation of the main roller 1.

For example, d1=0.2 m, N1=100 r, S1=3.14×0.2×100=62.8 m.

It should be noted that the number of turns of rotation of the main roller 1 can be read and fed back by an encoder of the motor used to drive the main roller 1 to rotate.

S120: judging whether the routing amount S1 of the main roller 1 is larger than the reference routing amount S0.

After the routing amount of the main roller 1 is acquired, the routing amount of the main roller 1 is compared with the reference routing amount to obtain a first judgment result. Based on the first judgment result, it is judged whether the wire roller meets the preset shaft diameter change condition. If the first judgment result indicates that the routing amount S1 of the main roller 1 is larger than the reference routing amount S0, step S200 is executed, that is, the target rotational speed n2 of the wire roller 41 is calculated.

Of course, if the first judgment result indicates that the routing amount S1 of the main roller 1 is not larger than the reference routing amount S0, the target rotational speed n2 of the wire roller 41 is not calculated, the wire roller 41 runs at the current rotational speed, and the process returns to step S110 for execution.

It should be noted that the present application does not limit the specific value of the reference routing amount S0. In practical applications, those skilled in the art can flexibly set the specific value of the reference routing amount S0 based on experiments or experience, as long as the critical point determined by the reference routing amount can avoid the occurrence of wire jumping or wire breakage in the wire cutting machine during the processing.

Preferably, the reference routing amount S0 is the routing amount within a set rotation time of the main roller 1.

For example, the diameter d1 of the main roller 1 is 0.2 m, and the rotational speed n1 of the main roller 1 is 3600 r/min, that is, the main roller 1 rotates by 60 r per second.

If the reference routing amount is the routing amount after the main roller 1 rotates for 1 second, then S0=3.14×0.2×60=37.68 m. When the routing amount S1 of the main roller 1 is larger than 37.38 m, the target rotational speed of the wire roller 41 is recalculated.

If the reference routing amount is the routing amount after the main roller 1 rotates for 5 seconds, then S0=3.14×0.2×300=188.4 m. When the routing amount S1 of the main roller 1 is larger than 188.4 m, the target rotational speed of the wire roller 41 is recalculated.

It should be noted that in practical applications, those skilled in the art can flexibly set the specific value of the set time based on experiments or experience. For example, the set time can be set to 1 second, 2 seconds, 3 seconds, 4 seconds, 5 seconds, 6 seconds, and so on. Of course, it is preferable to set the set time to 1 to 5 seconds.

Preferably, in a case where the wire cutting machine operates in a reciprocating wire supply cutting mode, before step S110 of “acquiring the routing amount S1 of the main roller 1” is executed, the control method of this embodiment further includes:
judging whether the main roller 1 is in a uniform speed stage; if it is judged that the main roller 1 is in the uniform speed stage, executing the step of “acquiring the routing amount S1 of the main roller 1”; otherwise, prohibiting the execution of the step of “acquiring the routing amount S1 of the main roller 1”.

The wire cutting machine generally has two working modes. The first working mode is unidirectional wire supply cutting, in which the main roller 1 always rotates in one direction. The second working mode is reciprocating wire supply cutting, in which the main roller 1 periodically rotates back and forth; during the process of changing the rotational direction of the main roller 1, the main roller 1 needs to decelerate first and then accelerate.

If the wire cutting machine operates in the reciprocating wire supply cutting mode, before executing step S110, it is necessary to first judge whether the main roller 1 is in the uniform speed stage. If the main roller 1 is just in the uniform speed stage, that is, the main roller 1 rotates at a uniform speed, then the routing amount of the main roller 1 can be acquired. On the contrary, if the main roller 1 is not in the uniform speed stage, the routing amount of the main roller 1 is not acquired first. After the main roller 1 completes acceleration and deceleration and rotates at a uniform speed, the routing amount of the main roller 1 is acquired. In this way, the accuracy of the acquired routing amount of the main roller 1 can be ensured.

S200: calculating the target rotational speed n2 of the wire roller 41.

The step of “calculating the target rotational speed n2 of the wire roller 41” specifically includes:
acquiring the routing amount S1 of the main roller 1; acquiring the change angle Δθ of the tension swing rod 51; calculating the routing amount S2 of the wire roller 41 based on the routing amount S1 of the main roller 1, the change angle Δθ′of the tension swing rod 51, and the length L of the tension swing rod 51; and calculating the target rotational speed n2 of the wire roller 41 based on the routing amount S2 of the wire roller 41.

The change angle Δθ of the tension swing rod 51 is the angle between the current position and the initial position of the tension swing rod 51. For example, as shown in FIG. 5, when the tension swing rod 51 swings toward the cutting chamber 2 of the wire cutting machine, the change angle Δθ is positive; on the contrary, when the tension swing rod 51 swings away from the cutting chamber 2 of the wire cutting machine, the change angle Δθ is negative.

The length L of the tension swing rod 51 is the length between a first endpoint (the point at which the tension swing rod 51 is fixedly connected to the first motor 42) and a second endpoint (the point at which the tension swing rod 51 is pivotally connected to the tension guide wheel 52) of the tension swing rod 51. The length L of the tension swing rod 51 can be pre-stored in a control device for the wire cutting machine.

It should be noted that the routing amount of the main roller 1 has already been acquired in the previous step, and there is no need to acquire it again at this time. The routing amount of the main roller 1 acquired previously can be directly used.

In addition, it should also be noted that the present application is not limited to using the above method to calculate the target rotational speed n2 of the wire roller 41. Those skilled in the art can also use other calculation methods to calculate the target rotational speed n2 of the wire roller 41. Of course, it is preferable to use the above calculation method in the present application to calculate the target rotational speed n2 of the wire roller 41.

Preferably, the step of “calculating the routing amount S2 of the wire roller 41 based on the routing amount S1 of the main roller 1, the change angle Δθ of the tension swing rod 51, and the length L of the tension swing rod 51” specifically includes:
calculating a wire length change amount AS based on the change angle Δθ of the tension swing rod 51 and the length L of the tension swing rod 51; and calculating the routing amount S2 of the wire roller 41 based on the routing amount S1 of the main roller 1 and the wire length change amount ΔS.

The wire length change amount ΔS=2×L×Δθ.

After obtaining the routing amount S1 of the main roller 1, the change angle Δθ of the tension swing rod 51, and the length L of the tension swing rod 51, the wire length change amount AS is first calculated based on the change angle Δθ and length L of the tension swing rod 51; then, the routing amount S2 of the wire roller 41 is calculated based on the routing amount S1 of the main roller 1 and the wire length change amount ΔS.

Preferably, the step of “calculating the routing amount S2 of the wire roller 41 based on the routing amount S1 of the main roller 1 and the wire length change amount AS” specifically includes:
when the wire roller 41 is in the unwinding state, calculating the routing amount S2 of the wire roller 41 based on a difference between the routing amount S1 of the main roller 1 and the wire length change amount AS; and
when the wire roller 41 is in the winding state, calculating the routing amount S2 of the wire roller 41 based on the sum of the routing amount S1 of the main roller 1 and the wire length change amount ΔS.

For example, when the wire roller 41 is in the unwinding state, the routing amount S2 of the wire roller 41 is S1−ΔS; and when the wire roller 41 is in the winding state, the routing amount S2 of the wire roller 41 is S1+ΔS.

It should be noted that in practical applications, when calculating the routing amount S2 of the wire roller 41 based on a difference between the routing amount S1 of the main roller 1 and the wire length change amount ΔS, S2 can also be the product of (S1−ΔS) and a weight coefficient (such as 0.9, 0.8, etc.), or S2 can also be the sum of (S1−ΔS) and a correction value, etc. This also applies to the situation of calculating the routing amount S2 of the wire roller 41 based on the sum of the routing amount S1 of the main roller 1 and the wire length change amount ΔS. Such flexible adjustments and changes do not deviate from the principles and scope of the present disclosure, and should all be defined within the scope of protection of the present disclosure.

Preferably, the step of “acquiring the change angle Δθ of the tension swing rod 51” specifically includes:
acquiring the current angle θ1 of the tension swing rod 51; and calculating the change angle Δθ of the tension swing rod 51 based on the current angle θ1 of the tension swing rod 51 and an initial angle θ of the tension swing rod 51.

The change angle Δθ of the tension swing rod 51 is θ1−θ.

For example, as shown in FIG. 4, in the initial state, the tension swing rod 51 is in a vertical state, that is, the initial angle θ of the tension swing rod 51 is 0°. As shown in FIG. 5, the current angle θ1 of the tension swing rod 51 is the angle between the current position of the tension swing rod 51 and the vertical plane. When the tension swing rod 51 swings to the right (i.e., toward the wire roller 41), the current angle θ1 of the tension swing rod 51 is positive. On the contrary, when the tension swing rod 51 swings to the left (i.e., away from the wire roller 41), the current angle θ1 of the tension swing rod 51 is negative.

It should be noted that the position information of the tension swing rod 51 can be read and fed back by the encoder of the first motor 42 used to drive the tension swing rod 51 to rotate.

In addition, it should also be noted that the initial angle of the tension swing rod 51 is not limited to the above-mentioned 0°. For example, the initial angle of the tension swing rod 51 can also be set to −1°, +1°, etc. Such adjustments and changes to the specific value of the initial angle of the tension swing rod 51 do not deviate from the principles and scope of the present disclosure, and should all be defined within the scope of protection of the present disclosure.

For example, the routing amount S1 of the main roller 1 is 40 m, the length L of the tension swing rod 51 is 0.3 m, and the change angle Δθ of the tension swing rod 51 is 2°.

First, the wire length change amount ΔS is calculated: ΔS=2×L×40=2×0.3×2=1.2 m.

If the wire roller 41 is in the unwinding state, S2=S1−ΔS=40−1.2=38.8 m.

If the wire roller 41 is in the winding state, S2=S1+ΔS=40+1.2=41.2 m.

Preferably, the step of “calculating the target rotational speed n2 of the wire roller 41 based on the routing amount S2 of the wire roller 41” specifically includes:

acquiring the number of turns N2 of rotation of the wire roller 41; and calculating the target rotational speed n2 of the wire roller 41 based on the number of turns N2 of rotation of the wire roller 41, the wire speed V of the cutting wire 3, and the routing amount S2 of the wire roller 41.

The target rotational speed n2 of the wire roller 41 is V×N2÷S2.

The wire speed V of the cutting wire 3 is set by the user before processing.

For example, V=2400 m/min, N2=60 r, S2=38.8 m, n2=2400×60÷38.8=3711 (r/min).

It should be noted that in practical applications, the present application is not limited to using the above calculation formula to calculate the target rotational speed of the wire roller 41. Those skilled in the art can also use other calculation methods to calculate the target rotational speed of the wire roller 41, which are not limited in the present application. Of course, it is preferable to use the above calculation formula in the present application to calculate the target rotational speed of the wire roller 41.

Preferably, in a case where the wire cutting machine operates in a reciprocating wire supply cutting mode, before executing step S200 of “calculating a target rotational speed n2 of the wire roller 41”, the control method of this embodiment further includes:
judging whether the main roller 1 is in a uniform speed stage; if it is judged that the main roller 1 is in the uniform speed stage, executing the step of “calculating a target rotational speed n2 of the wire roller 41”; otherwise, prohibiting the execution of the step of “calculating a target rotational speed n2 of the wire roller 41”.

As can be known from the above introduction, the wire cutting machine generally has a unidirectional wire supply cutting mode and a reciprocating wire supply cutting mode. When the wire cutting machine operates in the reciprocating wire supply cutting mode, before calculating the target rotational speed n2 of the wire roller 41, it is also necessary to first judge whether the main roller 1 is in the uniform speed stage. The step of “calculating a target rotational speed n2 of the wire roller 41” will be executed only when the main roller 1 is in the uniform speed stage.

S300: controlling the current rotational speed of the wire roller 41 to be the target rotational speed n2.

The target rotational speed of the wire roller 41 is the target rotational speed of the first motor 42 used to drive the wire roller 41 to rotate. After the target rotational speed n2 is calculated, it is sent to a controller of the first motor 42, and the first motor 42 drives the wire roller 41 to rotate at the new target rotational speed n2.

### Second Preferred Example

As shown in FIG. 8, the control method of this embodiment includes the following steps S110, S120, S200 and S300.

S110: acquiring the change angle Δθ of the tension swing rod 51.

S120: judging whether the change angle ∴θ of the tension swing rod 51 exceeds a preset interval.

The minimum value of the preset interval is negative, and the maximum value of the preset interval is positive.

The change angle Δθ of the tension swing rod 51 is the angle between the current position and the initial position of the tension swing rod 51. For example, as shown in FIG. 5, when the tension swing rod 51 swings toward the wire roller 41 of the wire cutting machine, the change angle Δθ is positive; on the contrary, when the tension swing rod 51 swings away from the wire roller 41 of the wire cutting machine, the change angle Δθ is negative.

After the change angle Δθ of the tension swing rod 51 is acquired, it is compared with the minimum and maximum values of the preset interval respectively to obtain a second judgment result. Based on the second judgment result, it is judged whether the wire roller 41 meets the preset shaft diameter change condition. If the second judgment result indicates that the change angle Δθ of the tension swing rod 51 exceeds the preset interval, step S200 is executed, that is, the target rotational speed n2 of the wire roller 41 is calculated.

Of course, if the second judgment result indicates that the change angle Δθ of the tension swing rod 51 does not exceed the preset interval, there is no need to recalculate the target rotational speed n2 of the wire roller 41, the wire roller 41 continues to rotate at the current rotational speed, and the process returns to step S110 for execution.

For example, the preset interval is (−1, 1). When Δθ<−1 or Δθ>1, the target rotational speed n2 of the wire roller 41 is calculated. However, when −1≤40≤1, the target rotational speed n2 of the wire roller 41 does not need to be calculated.

It should be noted that the preset interval is not limited to (−1, 1) mentioned above. For example, those skilled in the art can also set the preset interval to (−0.5, 1), (−1.5, 1.5), (−2, 1.5) and the like in practical applications. Those skilled in the art can flexibly set the specific numerical range of the preset interval based on experiments or experience, as long as the two critical points determined by the preset interval can avoid the occurrence of wire jumping or wire breakage in the wire cutting machine during the processing.

The step S110 of “acquiring the change angle Δθ of the tension swing rod 51” specifically includes:
acquiring the current angle Δθ of the tension swing rod 51; and calculating the change angle Δθ of the tension swing rod 51 based on the current angle Δθ of the tension swing rod 51 and an initial angle θ of the tension swing rod 51.

The change angle Δθ of the Tension Swing Rod 51 is θ1−θ.

For example, as shown in FIG. 4, in the initial state, the tension swing rod 51 is in a vertical state, that is, the initial angle θ of the tension swing rod 51 is 0°. As shown in FIG. 5, the current angle θ1 of the tension swing rod 51 is the angle between the current position of the tension swing rod 51 and the vertical plane. When the tension swing rod 51 swings to the right (i.e., toward the wire roller 41), the current angle θ1 of the tension swing rod 51 is positive. On the contrary, when the tension swing rod 51 swings to the left (i.e., away from the wire roller 41), the current angle θ1 of the tension swing rod 51 is negative.

It should be noted that the position information of the tension swing rod 51 can be read and fed back by the encoder of the first motor 42 used to drive the tension swing rod 51 to rotate.

In addition, it should also be noted that the initial angle of the tension swing rod 51 is not limited to the above-mentioned 0°. For example, the initial angle of the tension swing rod 51 can also be set to −1°, +1°, etc. Such definitions to the specific value of the initial angle of the tension swing rod 51 do not deviate from the principles and scope of the present disclosure, and should all be defined within the scope of protection of the present disclosure.

S200: calculating the target rotational speed n2 of the wire roller 41.

In this embodiment, the specific steps of “calculating the target rotational speed n2 of the wire roller 41” are the same as those introduced in the first embodiment above, and a repeated description will be omitted herein.

It should be noted that when executing the step of “calculating the target rotational speed n2 of the wire roller 41”, since the change angle Δθ of the tension swing rod 51 has already been acquired in the previous step, there is no need to acquire it again at this time. The change angle Δθ of the tension swing rod 51 acquired previously can be directly used.

Preferably, similar to the first embodiment described above, in a case where the wire cutting machine operates in a reciprocating wire supply cutting mode, before executing step S200 of “calculating a target rotational speed n2 of the wire roller 41”, the control method of this embodiment further includes:

judging whether the main roller 1 is in a uniform speed stage; if it is judged that the main roller 1 is in the uniform speed stage, executing the step of “calculating a target rotational speed n2 of the wire roller 41”; otherwise, prohibiting the execution of the step of “calculating a target rotational speed n2 of the wire roller 41”.

S300: controlling the current rotational speed of the wire roller 41 to be the target rotational speed n2.

The target rotational speed of the wire roller 41 is the target rotational speed of the first motor 42 used to drive the wire roller 41 to rotate. After the target rotational speed n2 is calculated, it is sent to a controller of the first motor 42, and the first motor 42 drives the wire roller 41 to rotate at the new target rotational speed n2.

### Second Embodiment

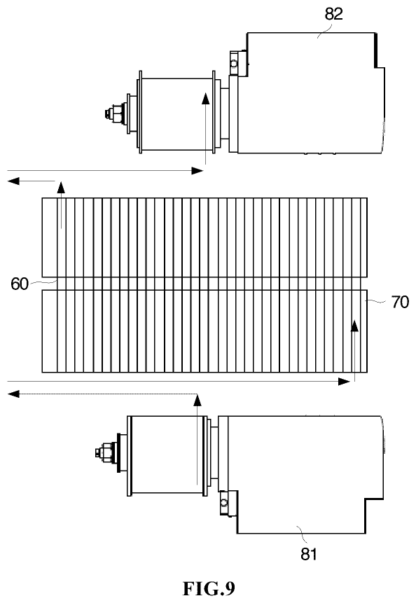

The technical solution of a second preferred embodiment of the present application will be described below in detail with reference to FIGS. 9 to 13.

Firstly, referring to FIG. 9, a wire saw unit in the prior art will be described. The arrows in FIG. 9 indicate the moving direction of the cutting wire.

As shown in FIG. 9, in the prior art, a third winding/unwinding assembly 81 and a fourth winding/unwinding assembly 82 of the wire saw unit are distributed on both sides of a main roller assembly 70, and are arranged axially symmetrically with respect to the main roller assembly 70. Taking the third winding/unwinding assembly 81 being in the unwinding state and the fourth winding/unwinding assembly 82 being in the winding state as an example, it can be clearly seen from FIG. 9 that when the cutting wire 60 forms a wire network, it is wound from the end on one side of the main roller assembly 70 toward the end on the opposite side of the main roller assembly 70 (wound from the bottom right end to the top left end in FIG. 9). Therefore, the current arrangement of the third winding/unwinding assembly 81 and the fourth winding/unwinding assembly 82 results in a shorter routing path of the cutting wire 60 on the winding side. During the cutting process, the cutting liquid sprayed on the wire network adheres to the cutting wire 60 and is brought into the winding chamber as the cutting wire 60 moves. After the cutting liquid evaporates, a large amount of powder adheres to the winding chamber and the fourth winding/unwinding assembly 82, affecting the stability of the fourth winding/unwinding assembly 82 and the wiring of the cutting wire 60.

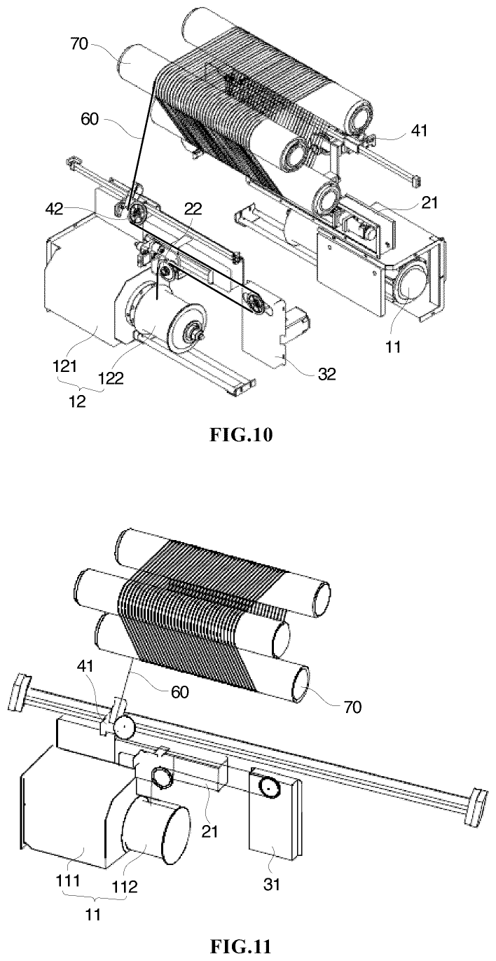

Referring to FIGS. 10 to 12, a wire saw unit of the present application will be described below.

As shown in FIGS. 10 to 12, in order to solve the problem that the cutting liquid easily enters the winding chamber with the cutting wire and affects the wiring of the winding roller, the wire saw unit of the present application includes a first winding/unwinding assembly 11 and a second winding/unwinding assembly 12. The first winding/unwinding assembly 11 and the second winding/unwinding assembly 12 are respectively arranged on opposite sides of the main roller assembly 70, and the arrangement direction of the first winding/unwinding assembly 11 is opposite to that of the second winding/unwinding assembly 12.

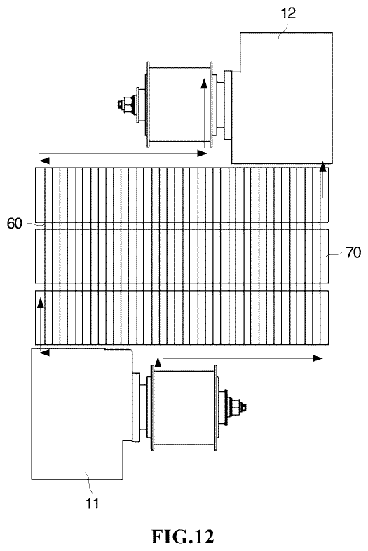

Referring to FIG. 12, taking the first winding/unwinding assembly 11 being in the unwinding state and the second winding/unwinding assembly 12 being in the winding state as an example, in the above arrangement, the cutting wire 60 is released from the first winding/unwinding assembly 11, and after being wound around the main roller assembly 70, it is recycled to the second winding/unwinding assembly 12. On the main roller assembly 70, the cutting wire 60 is still wound from the end on one side of the main roller assembly 70 toward the end on the opposite side of the main roller assembly 70 (wound from the bottom right end to the top left end in FIG. 12), and the first winding/unwinding assembly 11 and the second winding/unwinding assembly 12 are also arranged diagonally. In this way, the winding length of the second winding/unwinding assembly 12 is significantly increased. The situation where the second winding/unwinding assembly 12 is in the unwinding state and the first winding/unwinding assembly 11 is in the winding state is similar and will not be described repeatedly.

By arranging the first winding/unwinding assembly 11 and the second winding/unwinding assembly 12 in opposite directions, the routing path of the cutting wire can be extended when the winding/unwinding assembly on one side is in the winding state. In this way, the cutting liquid adhered to the cutting wire 60 is dried during the routing process, effectively reducing the accumulation of powder in the winding chamber and on the winding roller, and improving the operational stability of the winding roller.

Referring to FIGS. 10 to 12, a preferred implementation of the present application will be described below.

As shown in FIGS. 10 to 12, in a preferred implementation, the wire saw unit includes a first winding/unwinding assembly 11, a second winding/unwinding assembly 12, a first wiring wheel assembly 21, a second wiring wheel assembly 22, a first tension wheel assembly 31, a second tension wheel assembly 32, a first steering wheel assembly 41, and a second steering wheel assembly 42.

Specifically, the first winding/unwinding assembly 11 and the second winding/unwinding assembly 12 form a winding/unwinding mechanism, and they are arranged on both axial sides of the main roller assembly 70 respectively (i.e., the upper and lower sides of the main roller assembly 70 in FIG. 12). The first winding/unwinding assembly 11 can be used for unwinding the cutting wire 60, and the second winding/unwinding assembly 12 can be used for winding the cutting wire 60. Of course, when the first winding/unwinding assembly 11 is used for winding the cutting wire 60, the second winding/unwinding assembly 12 is correspondingly used for unwinding the cutting wire 60. The first winding/unwinding assembly 11 includes a first driving mechanism 111 and a first winding/unwinding roller 112. The first driving mechanism 111 corresponds to a first end of the main roller assembly 70 (the left end of the main roller assembly 70 shown in FIG. 12), and the first winding/unwinding roller 112 is connected to the first driving mechanism 111 and located in the middle part of the main roller assembly 70 on the side where it is located (the lower middle part shown in FIG. 12). The second winding/unwinding assembly 12 includes a second driving mechanism 121 and a second winding/unwinding roller 122. The second driving mechanism 121 corresponds to the opposite second end of the main roller assembly 70 (the right end of the main roller assembly 70 shown in FIG. 12), and the second winding/unwinding roller 122 is connected to the second driving mechanism 121 and located in the middle part of the main roller assembly 70 on the side where it is located (the upper middle part shown in FIG. 12).

In the present application, the first winding/unwinding assembly 11 and the second winding/unwinding assembly 12 have opposite arrangement directions. Here, “opposite arrangement directions” means that the winding/unwinding rollers of the first winding/unwinding assembly 11 and the second winding/unwinding assembly 12 are located on opposite sides. As shown in FIGS. 10-12, the first winding/unwinding roller 112 is located on a first side (the right side in FIG. 12) of the first driving mechanism 111, and conversely, the second winding/unwinding roller 122 is located on the opposite second side (the left side in FIG. 12) of the second driving mechanism 121. Preferably, the first winding/unwinding assembly 11 and the second winding/unwinding assembly 12 are in central-symmetry arrangement with respect to the main roller assembly 70. Here, “central-symmetry arrangement” refers to the rotational symmetry with respect to the central axis perpendicular to the paper surface of the main roller assembly 70 in the top view of FIG. 12, that is, the first winding/unwinding assembly 11 can rotate by 180° around the central axis to coincide with the position and structure of the second winding/unwinding assembly 12. After the arrangement, a distance of the cutting wire 60 from the first winding/unwinding assembly 11 to the main roller assembly 70 is equal to a distance of the cutting wire 60 from the second winding/unwinding assembly 12 to the main roller assembly 70.

With reference to FIGS. 10 and 11, the first wiring wheel assembly 21 is located on the side where the first winding/unwinding assembly 11 is located, and is used for wiring the first winding/unwinding assembly 11. The second wiring wheel assembly 22 is located on the side where the second winding/unwinding assembly 12 is located, and is used for wiring the second winding/unwinding assembly 12. The wiring direction of the first wiring wheel assembly 21 is opposite to that of the second wiring wheel assembly 22. Preferably, the first wiring wheel assembly 21 and the second wiring wheel assembly 22 are in central-symmetry arrangement with respect to the main roller assembly 70. The first wiring wheel assembly 21 and the second wiring wheel assembly 22 can adopt various feasible specific structures.

With continued reference to FIGS. 10 and 11, the first tension wheel assembly 31 is located on the side where the first winding/unwinding assembly 11 is located, and is used to provide a tension force to the cutting wire 60 between the main roller assembly 70 and the first winding/unwinding assembly 11. The second tension wheel assembly 32 is located on the side where the second winding/unwinding assembly 12 is located, and is used to provide a tension force to the cutting wire 60 between the main roller assembly 70 and the second winding/unwinding assembly 12. Preferably, the first tension wheel assembly 31 and the second tension wheel assembly 32 are in central-symmetry arrangement with respect to the main roller assembly 70. The first tension wheel assembly 31 and the second tension wheel assembly 32 can adopt various feasible specific structures.

Still with reference to FIGS. 10 and 11, the first steering wheel assembly 41 is located on the side where the first winding/unwinding assembly 11 is located, and is used to change the moving direction of the cutting wire 60 entering or exiting the main roller assembly 70; the second steering wheel assembly 42 is located on the side where the second winding/unwinding assembly 12 is located, and is used to change the moving direction of the cutting wire 60 entering or exiting the main roller assembly 70. Preferably, the first steering wheel assembly 41 and the second steering wheel assembly 42 are in central-symmetry arrangement with respect to the main roller assembly 70. The first steering wheel assembly 41 and the second steering wheel assembly 42 can adopt various feasible specific structures.

In the above arrangement, the first winding/unwinding assembly 11 and the second winding/unwinding assembly 12 are in central-symmetry arrangement, the first wiring wheel assembly 21 and the second wiring wheel assembly 22 are in central-symmetry arrangement, the first tension wheel assembly 31 and the second tension wheel assembly 32 are in central-symmetry arrangement, and the first steering wheel assembly 41 and the second steering wheel assembly 42 are in central-symmetry arrangement. The cutting wire 60 can be led out from the first winding/unwinding roller 112 of the first winding/unwinding assembly 11, sequentially passes through the first wiring wheel assembly 21, the first tension wheel assembly 31 and the first steering wheel assembly 41, then is wound onto the main roller assembly 70 from one end, and is unwound from the main roller assembly 70 from the other end. Then, it sequentially passes through the second steering wheel assembly 42, the second tension wheel assembly 32 and the second wiring wheel assembly 22, and is then wound onto the second winding/unwinding roller 122 of the second winding/unwinding assembly 12. In other words, the various components of the wire saw unit in the present application are in central-symmetry arrangement with respect to the main roller assembly 70.

Referring to FIG. 12, in the above arrangement, the routing distances of winding and unwinding of the cutting wire 60 are completely equal, that is, the distance of the cutting wire 60 from the first winding/unwinding roller 112 of the first winding/unwinding assembly 11 to the main roller assembly 70 is equal to the distance of the cutting wire 60 from the main roller assembly 70 to the second winding/unwinding roller 122 of the second winding/unwinding assembly 12.

The central-symmetry arrangement of the first winding/unwinding assembly 11 and the second winding/unwinding assembly 12 is advantageous for improving the routing symmetry of the cutting wire 60 and reducing the difficulty in controlling the cutting wire 60. The wiring direction of the first wiring wheel assembly 21 is opposite to that of the second wiring wheel assembly 22, which is advantageous for adapting to the directions of the first winding/unwinding assembly 11 and the second winding/unwinding assembly 12. The central-symmetry arrangement of the first wiring wheel assembly 21 and the second wiring wheel assembly 22 is advantageous for improving the routing symmetry of the cutting wire 60 and reducing the difficulty in controlling the cutting wire 60. The central-symmetry arrangement of the first tension wheel assembly 31 and the second tension wheel assembly 32 is advantageous for improving the routing symmetry of the cutting wire 60 and reducing the difficulty in controlling the cutting wire 60. The central-symmetry arrangement of the first steering wheel assembly 41 and the second steering wheel assembly 42 is advantageous for improving the routing symmetry of the cutting wire 60 and reducing the difficulty in controlling the cutting wire 60.

By arranging the routing distances of winding and unwinding of the cutting wire 60 to be completely equal, it is also possible to achieve undifferentiated mutual conversion between the first winding/unwinding assembly 11 and the second winding/unwinding assembly 12. In other words, after the cutting wire 60 is completely released from the first winding/unwinding assembly 11 to the second winding/unwinding assembly 12, there is no need to rewind it. It is only required to control the first winding/unwinding assembly 11 and the second winding/unwinding assembly 12 to operate in the opposite direction to achieve undifferentiated running of the cutting wire 60 in the opposite direction.

It should be noted that the above preferred implementations are only intended to illustrate the principles of the present application, and are not intended to limit the scope of protection of the present application. Without deviating from the principles of the present application, those skilled in the art may adjust the above arrangements so that the present application can be applied to more specific application scenarios.

For example, although the first winding/unwinding assembly 11 and the second winding/unwinding assembly 12 in the above implementations are described as being in central-symmetry arrangement, this is only a preferred implementation, and those skilled in the art can adjust their arrangement positions, as long as the first winding/unwinding assembly 11 and the second winding/unwinding assembly 12 are arranged in opposite directions to each other. For example, it is possible for the first winding/unwinding assembly 11 and the second winding/unwinding assembly 12 to be not in central-symmetry arrangement; of course, such an arrangement is not advantageous for improving the routing symmetry.

For another example, although the above implementations are described using an example in which the first winding/unwinding assembly 11 and the second winding/unwinding assembly 12 are distributed on both axial sides of the main roller assembly 70 (the upper and lower sides of the main roller assembly 70 in FIG. 12), this is not intended to limit the scope of protection of the present application. In other implementations, the first winding/unwinding assembly 11 and the second winding/unwinding assembly 12 may also be positioned at both axial ends of the main roller assembly 70 respectively (i.e., the left and right sides of the main roller assembly 70 in FIG. 12).

For further another example, although the above implementations are described using an example in which the wire saw unit includes the first wiring wheel assembly 21, the second wiring wheel assembly 22, the first tension wheel assembly 31, the second tension wheel assembly 32, the first steering wheel assembly 41 and the second steering wheel assembly 42, the specific composition of the wire saw unit is not unique, and can be adjusted by those skilled in the art according to their needs. For example, those skilled in the art can selectively delete one set of the assemblies mentioned above, such as deleting the first tension wheel assembly 31 and the second tension wheel assembly 32. Alternatively, those skilled in the art can selectively delete only part of the assemblies mentioned above, such as deleting the first steering wheel assembly 41 or the second steering wheel assembly 42, etc.

For still further another example, although the first wiring wheel assembly 21, the second wiring wheel assembly 22, the first tension wheel assembly 31, the second tension wheel assembly 32, the first steering wheel assembly 41 and the second steering wheel assembly 42 in the above implementations are all described as being in central-symmetry arrangement in pairs respectively, this is only a preferred implementation of the present application. In other implementations, those skilled in the art can arrange the above assemblies according to specific needs. For example, at least one set of correspondingly arranged assemblies mentioned above can be not in central-symmetry arrangement. Of course, such an arrangement is not advantageous for improving the routing symmetry.

Of course, the above alternative implementations, as well as the alternative implementations and preferred implementations, can also be used in combination and in cooperation with each other to obtain new implementations that can be applied to more specific application scenarios.

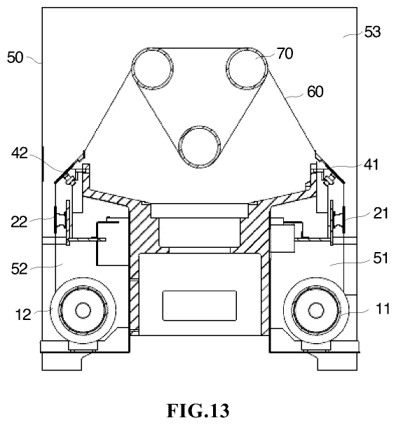

Referring to FIG. 13, the wire cutting machine of the present application will be described below.

As shown in FIG. 13, the present application also provides a wire cutting machine, which includes the wire saw unit in the above implementation on the basis of the above first embodiment.

In a specific implementation, the wire cutting machine is preferably a slicer, which includes a cutting frame 50. The cutting frame 50 is formed with a cutting chamber 53, a first winding chamber 51, and a second winding chamber 52. Both the first winding chamber 51 and the second winding chamber 52 are located on a lower side of the cutting chamber 53. The main roller assembly 70 is arranged in the cutting chamber 53. The first winding/unwinding assembly 11, the first wiring wheel assembly 21, the first tension wheel assembly 31 and the first steering wheel assembly 41 are arranged in the first winding chamber 51; the second winding/unwinding assembly 12, the second wiring wheel assembly 22, the second tension wheel assembly 32 and the second steering wheel assembly 42 are arranged in the second winding chamber 52. The cutting wire 60 can be released from the first winding/unwinding assembly 11 of the first winding chamber 51, sequentially passes through the first wiring wheel assembly 21, the first tension wheel assembly 31 and the first steering wheel assembly 41 before reaching the cutting chamber 53, and is wound onto the main roller assembly 70. Then, it is discharged from the cutting chamber 53, sequentially passes through the second steering wheel assembly 42, the second tension wheel assembly 32 and the second wiring wheel assembly 22 before being wound onto the second winding/unwinding assembly 12, and is recycled to the second winding chamber 52. Vice-versa, the cutting wire 60 can be released from the second winding chamber 52 and ultimately recycled to the first winding chamber 51.

By using the above-mentioned wire saw unit in the wire cutting machine, the routing path of the cutting wire 60 can be extended when one of the winding/unwinding rollers is used as the winding side, effectively reducing the accumulation of powder in the winding chamber and on the winding/unwinding rollers, improving the operational stability of the winding roller, and enhancing the cutting quality.

Of course, the specific structure of the wire cutting machine mentioned above is only a preferred implementation, and those skilled in the art can adjust the specific structural arrangement of the wire cutting machine based on specific application scenarios. For example, the two winding chambers can also be arranged at other positions. For another example, the wire cutting machine can also be other wire cutting equipment, such as mortar mill.

It should be noted that although the detailed steps of the method of the present application have been described above in detail, those skilled in the art can combine and split the above steps, and change the order of the above steps without departing from the basic principles of the present application. The thus-modified technical solutions do not change the basic concept of the present application, and therefore also fall within the scope of protection of the present application.

It should also be noted that the various component embodiments of the present application can be implemented in hardware, or software modules running on one or more processors, or a combination thereof. It should be understood by those skilled in the art that microprocessors or digital signal processors (DSPs) can be used in practice to implement some or all of the functions of some or all components in the server and client according to the embodiments of the present application. The present application can also be implemented as a device or apparatus program (e.g., PC program and PC program product) for executing part or all of the methods described herein. Such programs for implementing the present application can be stored on a PC readable medium, or can take the form of one or more signals. Such signals can be downloaded from internet websites, or provided on carrier signals, or provided in any other form.

In addition, it can be understood by those skilled in the art that although some embodiments described herein include certain features included in other embodiments rather than other features, combinations of features of different embodiments means that they are within the scope of the present application and form different embodiments. For example, in the claims of the present application, any one of the claimed embodiments can be used in any combination.

The present application also provides a computer-readable storage medium. In an embodiment of the computer-readable storage medium according to the present application, the computer-readable storage medium may be configured to store a program for executing the control method for a wire cutting machine of the method embodiment described above, and the program can be loaded and executed by a processor to implement the control method for a wire cutting machine described above. For ease of explanation, only the parts related to the embodiments of the present disclosure are shown. For specific technical details not disclosed, reference may be made to the method section of the embodiments of the present disclosure. The computer-readable storage medium may be a storage apparatus including various electronic devices. Optionally, in the embodiments of the present disclosure, the computer-readable storage medium is a non-temporary computer-readable storage medium.

The present application also provides a control device. In an embodiment of the control device according to the present application, the control device includes a processor and a memory; the memory may be configured to store a program for executing the control method for a wire cutting machine of the method embodiment described above, and the processor may be configured to execute the program in the memory, including but not limited to a program for executing the control method for a wire cutting machine of the method embodiment described above. For ease of explanation, only the parts related to the embodiments of the present disclosure are shown. For specific technical details not disclosed, reference may be made to the method section of the embodiments of the present disclosure. The control device may be an apparatus including various electronic devices.

Of course, the specific arrangement and composition of the wire cutting machine mentioned above only belong to a preferred implementation. Without departing from the principles of the present application, those skilled in the art can adjust the composition and arrangement of the wire cutting machine mentioned above.

Hitherto, the technical solutions of the present application have been described in connection with the preferred embodiments shown in the accompanying drawings, but it is easily understood by those skilled in the art that the scope of protection of the present application is obviously not limited to these specific embodiments. Without departing from the principles of the present application, those skilled in the art can make equivalent changes or replacements to relevant technical features, and all the technical solutions after these changes or replacements will fall within the scope of protection of the present application.

1. A control method for a wire cutting machine, the wire cutting machine comprising a cutting assembly and a winding assembly, the cutting assembly comprising multiple main rollers, and the winding assembly comprising a winding/unwinding mechanism that comprises a wire roller, characterized in that the control method comprises:
judging whether the wire roller meets a preset shaft diameter change condition;
calculating a target rotational speed n2 of the wire roller if the preset shaft diameter change condition is met; and
controlling the current rotational speed of the wire roller to be the target rotational speed n2, so that a difference between the wire speed of the cutting wire on the wire roller and the wire speed of the cutting wire on the main roller is within a set difference.

2. The control method for a wire cutting machine according to claim 1, wherein the winding assembly further comprises a tension mechanism, the tension mechanism comprises a tension swing rod, and the step of “calculating a target rotational speed n2 of the wire roller” specifically comprises:
acquiring a routing amount S1 of the main roller;
acquiring a change angle Δθ of the tension swing rod;
calculating a routing amount S2 of the wire roller based on the routing amount S1 of the main roller, the change angle Δθ of the tension swing rod, and the length L of the tension swing rod; and
calculating the target rotational speed n2 of the wire roller based on the routing amount S2 of the wire roller.

3. The control method for a wire cutting machine according to claim 2, wherein the step of “calculating the target rotational speed n2 of the wire roller based on the routing amount S2 of the wire roller” specifically comprises:
acquiring the number of turns N2 of rotation of the wire roller; and
calculating the target rotational speed n2 of the wire roller based on the number of turns N2 of rotation of the wire roller, the wire speed V of the cutting wire, and the routing amount S2 of the wire roller; and/or
the step of “calculating a routing amount S2 of the wire roller based on the routing amount S1 of the main roller, the change angle Δθ of the tension swing rod, and the length L of the tension swing rod” specifically comprises:
calculating a wire length change amount ΔS based on the change angle Δθ of the tension swing rod and the length L of the tension swing rod; and
calculating the routing amount S2 of the wire roller based on the routing amount S1 of the main roller and the wire length change amount ΔS.

4. The control method for a wire cutting machine according to claim 3, wherein the step of “calculating the routing amount S2 of the wire roller based on the routing amount S1 of the main roller and the wire length change amount AS” specifically comprises:
when the wire roller is in an unwinding state, calculating the routing amount S2 of the wire roller based on a difference between the routing amount S1 of the main roller and the wire length change amount ΔS; and
when the wire roller is in a winding state, calculating the routing amount S2 of the wire roller based on the sum of the routing amount S1 of the main roller and the wire length change amount ΔS; and/or
the step of “acquiring a change angle Δθ of the tension swing rod” specifically comprises:
acquiring the current angle θ1 of the tension swing rod; and
calculating the change angle Δθ of the tension swing rod based on the current angle θ1 of the tension swing rod and an initial angle θ of the tension swing rod; preferably, the initial angle θ of the tension swing rod is 0°.

5. The control method for a wire cutting machine according to claim 1, wherein the step of “judging whether the wire roller meets a preset shaft diameter change condition” specifically comprises:
acquiring a routing amount S1 of the main roller;
judging whether the routing amount S1 of the main roller is larger than a reference routing amount S0;
obtaining a first judgment result; and
judging whether the wire roller meets the preset shaft diameter change condition based on the first judgment result;
the step of “calculating a target rotational speed n2 of the wire roller if the preset shaft diameter change condition is met” specifically comprises:
if the first judgment result indicates that the routing amount S1 of the main roller is larger than the reference routing amount S0, then calculating the target rotational speed n2 of the wire roller; and/or
the winding assembly further comprises a tension mechanism, the tension mechanism comprises a tension swing rod, and the step of “judging whether the wire roller meets a preset shaft diameter change condition” specifically comprises:
acquiring a change angle Δθ of the tension swing rod;
judging whether the change angle Δθ of the tension swing rod exceeds a preset interval;
obtaining a second judgment result; and
judging whether the wire roller meets the preset shaft diameter change condition based on the second judgment result;
the step of “calculating a target rotational speed n2 of the wire roller if the preset shaft diameter change condition is met” specifically comprises:
if the second judgment result indicates that the change angle Δθ of the tension swing rod exceeds the preset interval, then calculating the target rotational speed n2 of the wire roller;
wherein the minimum value of the preset interval is negative, and the maximum value of the preset interval is positive.

6. The control method for a wire cutting machine according to claim 5, wherein the reference routing amount S0 is the routing amount within a set rotation time of the main roller; and/or
in a case where the wire cutting machine operates in a reciprocating wire supply cutting mode, before the step of “acquiring the routing amount S1 of the main roller” is executed, the control method further comprises:
judging whether the main roller is in a uniform speed stage; and
if it is judged that the main roller is in the uniform speed stage, then executing the step of “acquiring the routing amount S1 of the main roller”; otherwise, prohibiting the execution of the step of “acquiring the routing amount S1 of the main roller”.

7. The control method for a wire cutting machine according to claim 1, wherein in a case where the wire cutting machine operates in a reciprocating wire supply cutting mode, before the step of “calculating the target rotational speed n2 of the wire roller” is executed, the control method further comprises:
judging whether the main roller is in a uniform speed stage;
if it is judged that the main roller is in the uniform speed stage, then executing the step of “calculating a target rotational speed n2 of the wire roller”; otherwise, prohibiting the execution of the step of “calculating a target rotational speed n2 of the wire roller”; and/or
the value range of the set difference is any value from 0.1 m/min to 0.8 m/min.

8. A control device, characterized by comprising a processor and a memory, wherein the memory is adapted to store multiple program codes, and the program codes are adapted to be loaded and run by the processor to execute the control method for a wire cutting machine according to claim 1.

9. A wire cutting machine, characterized by comprising the control device according to claim 8.

10. The wire cutting machine according to claim 9, wherein a wire saw unit of the wire cutting machine comprises the winding/unwinding mechanism, and the winding/unwinding mechanism comprises a first winding/unwinding assembly and a second winding/unwinding assembly; the first winding/unwinding assembly and the second winding/unwinding assembly are respectively arranged on two opposite sides of the main roller assembly, and an arrangement direction of the first winding/unwinding assembly is opposite to that of the second winding/unwinding assembly; preferably, the first winding/unwinding assembly and the second winding/unwinding assembly are in central-symmetry arrangement with respect to the main roller assembly.

11. The wire cutting machine according to claim 10, wherein the first winding/unwinding assembly and the second winding/unwinding assembly are arranged on two axial sides of the main roller assembly respectively;
the first winding/unwinding assembly comprises a first driving mechanism and a first winding/unwinding roller, the first driving mechanism corresponds to a first end of the main roller assembly, and the first winding/unwinding roller is connected to the first driving mechanism and located between two ends on the side where it is located; and
the second winding/unwinding assembly comprises a second driving mechanism and a second winding/unwinding roller, the second driving mechanism corresponds to the opposite second end of the main roller assembly, and the second winding/unwinding roller is connected to the second driving mechanism and located between two ends on the side where it is located.

12. The wire cutting machine according to any one of claims 10, wherein a distance of the cutting wire from the first winding/unwinding assembly to the main roller assembly is equal to a distance of the cutting wire from the second winding/unwinding assembly to the main roller assembly; and/or
the first winding/unwinding assembly can be used for winding or unwinding, and correspondingly, the second winding/unwinding assembly can be used for unwinding or winding.

13. The wire cutting machine according to claim 10, wherein the wire saw unit further comprises a first wiring wheel assembly and a second wiring wheel assembly; the first wiring wheel assembly is arranged on the side where the first winding/unwinding assembly is located, and is used for wiring the first winding/unwinding assembly; the second wiring wheel assembly is arranged on the side where the second winding/unwinding assembly is located, and is used for wiring the second winding/unwinding assembly; a wiring direction of the first wiring wheel assembly is opposite to that of the second wiring wheel assembly; preferably, the first wiring wheel assembly and the second wiring wheel assembly are in central-symmetry arrangement with respect to the main roller assembly; and/or
the wire saw unit further comprises a first tension wheel assembly and a second tension wheel assembly; the first tension wheel assembly is arranged on the side where the first winding/unwinding assembly is located, and is used to adjust a tension force of the cutting wire between the main roller assembly and the first winding/unwinding assembly; the second tension wheel assembly is arranged on the side where the second winding/unwinding assembly is located, and is used to adjust a tension force of the cutting wire between the main roller assembly and the second winding/unwinding assembly; preferably, the first tension wheel assembly and the second tension wheel assembly are in central-symmetry arrangement with respect to the main roller assembly; and/or
the wire saw unit further comprises a first steering wheel assembly and a second steering wheel assembly; the first steering wheel assembly is arranged on the side where the first winding/unwinding assembly is located, and is used to change the moving direction of the cutting wire entering or exiting the main roller assembly; the second steering wheel assembly is arranged on the side where the second winding/unwinding assembly is located, and is used to change the moving direction of the cutting wire entering or exiting the main roller assembly; preferably, the first steering wheel assembly and the second steering wheel assembly are in central-symmetry arrangement with respect to the main roller assembly.

14. The wire cutting machine according to claim 10, wherein the wire cutting machine comprises a cutting chamber and two winding chambers that are located on a lower side of the cutting chamber; the first winding/unwinding assembly and the second winding/unwinding assembly are located in the two winding chambers respectively; and/or
the wire cutting machine is a slicer.
